(19) United States
(12) Patent Application Publication
(10) Pub. No.: US 2004/0066889 A1
(43) Pub. Date: Apr. 8, 2004

(54) Collimator aperture scheduling for enhanced pencil-beam resolution

(76) Inventor: Roderick D. Swift, Belmont, MA (US)

Correspondence Address: BROMBERG & SUNSTEIN LLP, 125 SUMMER STREET, BOSTON, MA, 02110-1618, US

(21) Appl. No.: 10/458,077

(22) Filed: Jun. 10, 2003

Related U.S. Application Data
(60) Provisional application No. 60/387,504, filed on Jun. 10, 2002.

(51) Int. Cl. G01N 23/04

(52) U.S. Cl. 378/57

(57) ABSTRACT

A system and method for inspecting an object. The system has a source for generating a penetrating radiation beam for irradiating the object and at least one detector for detecting the beam after the beam interacts with the object. Furthermore, the system has an aperture interposed between the source and the object, the aperture characterized by a cross-sectional dimension, and the cross-sectional dimension capable of variation on a periodic basis during the course of inspecting the object such that high resolution is obtained for regions of the object characterized by lower opacity while penetration is achieved at lower spatial resolution for regions of more substantial opacity.

The present application claims priority from U.S. Provisional Application Serial No. 60/387,504, filed Jun. 10, 2002, which is herein incorporated by reference.

### TECHNICAL FIELD

The present invention relates to systems and methods for inspecting objects with penetrating radiation, and, more particularly, the invention relates to a variable collimating aperture that provides for optimizing resolution and sensitivity with respect to objects of inhomogeneous opacity.

### BACKGROUND OF THE INVENTION

X-ray inspection systems, such as those used to characterize the contents of concealing enclosures such as baggage or cargo containers, may typically employ an irradiating beam of specified cross-section which is swept relative to the enclosure while portions of the beam that are either transmitted through the enclosure or scattered by objects within it are detected.

Various means are known in the art for mechanically or electronically sweeping a beam of penetrating radiation, including, for example, the rotating chopper wheel depicted in FIG. 1. As chopper wheel 10 rotates in the direction of arrow 12, the penetrating radiation 14 emitted from the target of X-ray tube 16 passes successively through a plurality of channels 18 (four channels in the embodiment depicted in FIG. 1). Wheel 10 is fabricated from a material, typically lead, that blocks transmission of x-rays except through channels 18. X-rays 14 emerge from a channel that is illuminated by x-rays at any particular instant of time, as a pencil beam 20 that is swept across an object undergoing inspection as wheel 10 rotates. FIGS. 2A-2C illustrate the varying direction of beam 20 as one of channels 18 rotates with chopper wheel 10. During a small portion of the rotation of wheel 10, it may be provided that no radiation is emitted, as depicted in FIG. 2D. A system employing a scanned beam where the dimensions of the beam govern the resolution of the system may also be referred to as a “flying-spot” x-ray examining system.

FIG. 3 is a schematic cross-sectional view of an x-ray inspection system in which a scanning pencil beam 20 generated by x-ray radiation source 30 is employed to scan an inspected enclosure such as truck 32. Portions of beam 20 that traverse the inspected enclosure are detected by transmission detector 34, whereas scattered x-rays 36 are detected by one or more scatter detectors 38.

Since the resolution of a flying-spot system, and thus the ability to detect small articles, depends strongly on collimation of the beam into a well-defined pencil beam, it is advantageous to limit the size of region illuminated by the beam to dimensions no bigger than those of a detection pixel, subject to constraints driven by sampling time and scanning speeds. Collimation of the beam is achieved by means of an aperture defined at the position where a beam exits a channel of the chopper wheel.

### SUMMARY OF THE INVENTION

In accordance with one aspect of the invention, a system and method are provided for inspecting an object. The system has a source for generating a penetrating radiation beam for irradiating the object and at least one detector for detecting the beam after the beam interacts with the object. Furthermore, the system has an aperture interposed between the source and the object, the aperture characterized by a cross-sectional dimension, and the cross-sectional dimension capable of variation on a periodic basis during the course of inspecting the object.

In accordance with alternate embodiments of the invention, the source for generating a penetrating radiation beam may include a chopper wheel having a periphery and a plurality of through-channels capable of rotation in such a manner as to scan the beam across the object. The source for generating a penetrating radiation beam may include an x-ray tube and an aperture may be disposed at the periphery of the chopper wheel at each through-channel.

### BRIEF DESCRIPTION OF THE DRAWINGS

The foregoing features of the invention will be more readily understood by reference to the following detailed description, taken with reference to the accompanying drawings, in which:

FIG. 1 is a cutaway perspective view of a rotating chopper wheel used in the prior art to scan a beam of penetrating radiation across an inspected object;

FIGS. 2A-2D show schematics of a prior art rotating chopper wheel and an emergent beam of penetrating radiation;

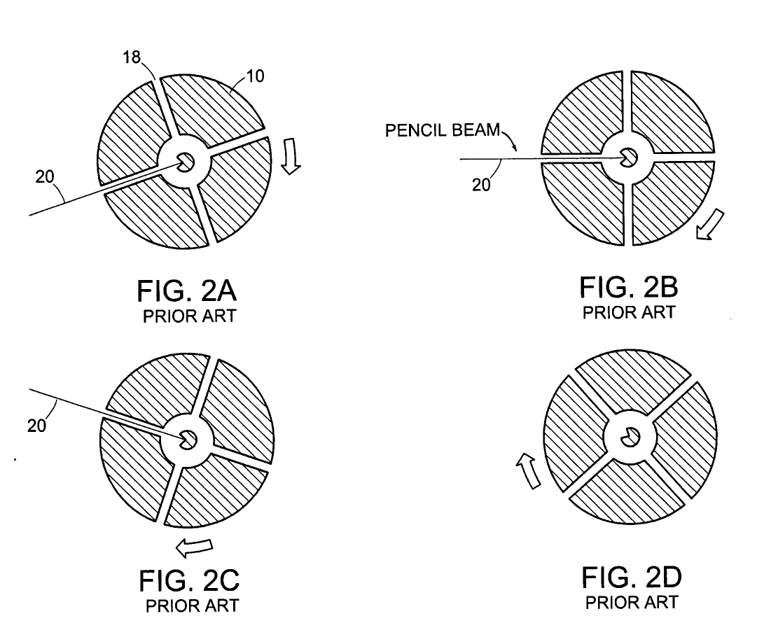

FIG. 3 is a schematic cross-sectional view of an exemplary embodiment of an inspection system using a collimated pencil beam in accordance with the invention; and

FIG. 4 is a ray trace of x-rays collimated by an aperture in accordance with the invention.

### DETAILED DESCRIPTION OF SPECIFIC EMBODIMENTS

Design of an x-ray inspection system to examine heterogeneous cargo requires joint consideration of conflicting requirements for resolution and sensitivity. The flux of x-rays incident on the detection region during the dwell time corresponding to a resolution element must suffice to provide an adequate signal to noise ratio. The reciprocal of the sample time per pixel may be referred to herein as the sampling frequency.

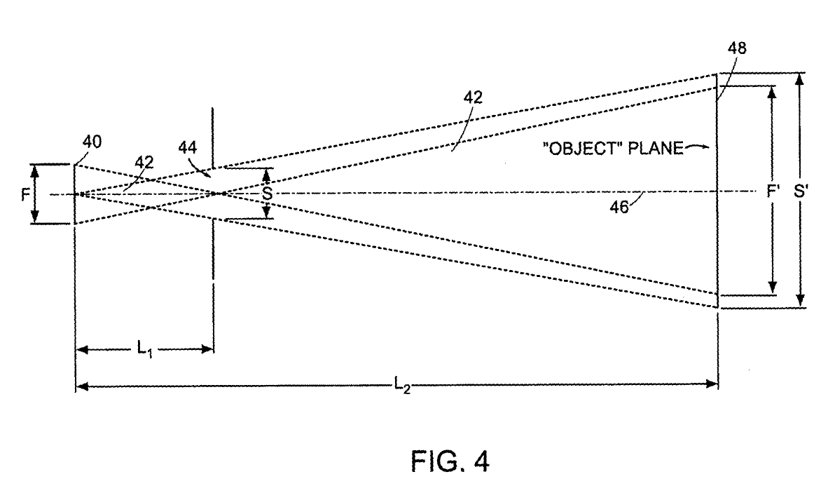

Referring to FIG. 4, the relative placement of the components of an inspection system is shown. A target 40 represents the region, typically the focal region of an x-ray tube, from which photons are emitted. While the system is described herein with respect to an x-ray tube, it is to be understood that any source of irradiation (or illumination) is within the scope of the present invention, and that the radiation of target 40 may correspond to a Lambertian distribution of radiation, or otherwise. For some applications, a pulsed x-ray generator with an appropriate repetition rate may be used. In a typical arrangement, an x-ray tube 16 has an anode, commonly of tungsten, that generates x-rays at the focus 40 of an electron beam. The radiated beam 42 of penetrating radiation, may be, for example, a beam of x-rays such as a polychromatic x-ray beam. Beam 42 will be referred to in the present description, without limitation, as an x-ray beam. And while a penetrating beam refers to a beam of radiation capable of penetrating the inspected object to some degree, and while a high-energy beam such as an x-ray beam is typically contemplated, it is to be understood that, insofar as the object transmits light or radiation in other parts of the electromagnetic spectrum, the present teachings are also applicable, though the description pertains particularly in the short-wave (i.e., ‘geometrical’, or λ<<d, where λ is a typical wavelength of the beam and d is a typical aperture dimension) limit.

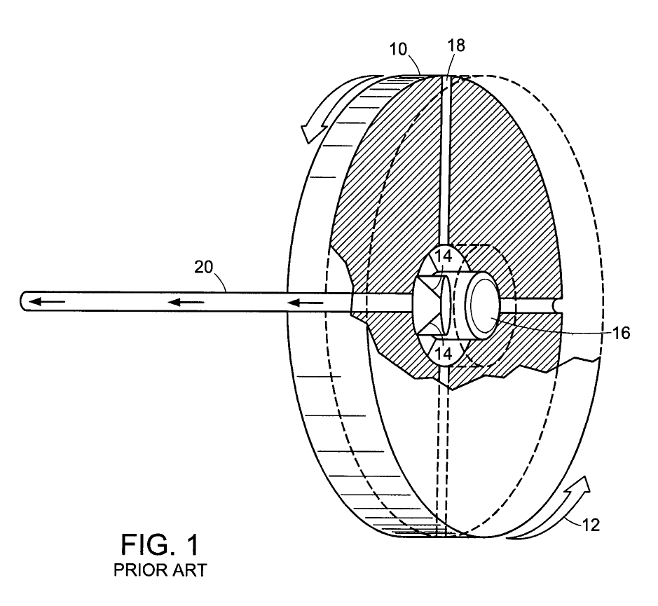

Rotating chopper wheel 10 (as shown in FIG. 1) is not depicted in FIG. 4 other than as the path through which beam 42 propagates from target 40 to a beam-defining aperture 44. Beam-defining aperture 44 is a collimating aperture placed at the distal end of each channel 18 of chopper wheel 10 at the point where beam 42 emerges from the wheel, a distance L₁ from the focal spot 40. Aperture 44 may have various shapes, and may be circular or rectangular, and is also characterized by a thickness. The description of the invention proceeds with reference to the cross-sectional view of the aperture shown in FIG. 4, with the understanding that the actual system may have cylindrical symmetry about central axis 46, but that it typically does not. A characteristic dimension, referred to herein as the “size”, of the focal spot at target 40 is designated as F, while the size (or opening) of aperture 44 is designated S.

Object plane 48 refers to a characteristic position within an object being interrogated at which resolution is derired to be optimzed. It is to be understood that, while refered to as a ‘plane’, object image 48 may, in fact, be formed on an arcuate surface, for example. F′ represents the size of a pinhole image of the focal spot (i.e., the image through an infinitesimal aperture, S→0) at the designated “object distance”, L₂ referred to the plane of target 40, while S′ represents a point projection of the aperture (i.e., from a point source, F∝0).

At object plane 48,

F′=F(L₂−L₁)/L₁; and S′=SL₂/L₁. (Eqns. 1)

The full beam spread at the object distance is the convolute of F′ and S′, which as a maximum width equal to the sum of F′ and S′, and a full-width at half-maximum (FWHM) equal to the larger of F′ and S′.

The size of F is typically governed by the choice of x-ray tube (though it might be variable, within the scope of the invention), while L₁ and L₂ are typically dictated by other system considerations such as the size of objects being scanned and the maximum practical size of a chopper wheel that can scan beam 42 at a sufficiently high rate, etc., and S is then typically dimensioned to make F′ and S′ equal, i.e.,

S=F(L₂−L₁)/L₂. (Eqn. 2)

The flux of x-rays per unit time in the scanning beam is substantially proportional to the product F×S², or, using Eqn. 2, to F³. Ideally, both F′ and S′ are equal to the pixel size at the object distance, however, this may lead, in view of the small pixel size desired, to an x-ray flux that is too small and thus to a loss of penetration, i.e., to an undesirable limit on how much attenuation may be probed by the interrogating beam. A further limitation on F may be provided by a choice of commercially-available x-ray tubes.

Consequently, it is common practice to select an available F and to design S in accordance with Eqn. 2 but subject to the condition of providing adequate flux for the desired application. Thus, optimal resolution is not obtained in cases where the beam attenuation is low, i.e., in paths through the inspected object that are radiographically “thin.” Conversely, for “thick” parts of the object (i.e., more highly attenuating of incident penetrating radiation), higher photon flux is required for penetration, even at the expense of resolution.

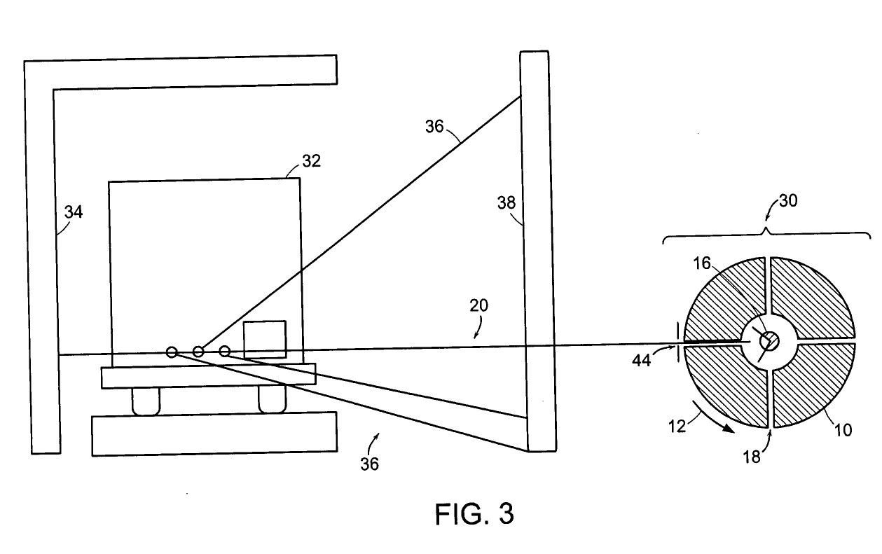

In accordance with a preferred embodiment of the invention, fixed apertures 44 of different sizes may be used at distal ends of respective chopper channels 18. As one example, provided without limitation, three of four channels (the configuration depicted in FIG. 3) may be ‘small’ yielding high resolution data (albeit, at times, flux-starved), for features having sufficient contrast to be detected with the reduced photon statistics. The remaining aperture, out of four, is enlarged, by comparison, so that, in combination with the three smaller apertures, it will provide the same average flux over a 4-pixel area as a comparable system might with equal apertures. Thus, strongly attenuated, or very low contrast regions of the object, may be seen with a contrast indistinguishable from that achieved were all the apertures to be of a larger, and equal, size.

Once the principal is understood, a variable collimating aperture size during the course of a scan may be achieved in many ways. For example, still using channels of a rotating chopper wheel, there may be a greater or lesser number of the channels having relatively larger or smaller apertures. Alternatively, apertures may be inserted, on a time-varying basis, into the path between source 30 and object 32, or the size of an intervening aperture may be varied mechanically or otherwise.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A system for inspecting an object, the system comprising:
a. a source for generating a penetrating radiation beam for irradiating the object;
b. at least one detector for detecting the beam after the beam interacts with the object; and
c. a beam-defining aperture interposed between the source and the object, the beam-defining aperture characterized by an instantaneous cross-sectional dimension, and the cross-sectional dimension capable of variation on a periodic basis during the course of inspecting the object.

2. The inspection system according to claim 1 wherein the source for generating a penetrating radiation beam includes a chopper wheel having a periphery and a plurality of through-channels capable of rotation in such a manner as to scan the beam across the object.

3. The inspection system according to claim 1 wherein the source for generating a penetrating radiation beam includes an x-ray tube.

4. The inspection system according to claim 2, wherein a fixed aperture is disposed at the periphery of the chopper wheel at each through-channel.

5. A method for inspecting an object, the method comprising:
a. generating a penetrating radiation beam with a source of radiation;
b. scanning the penetrating radiation beam across the object;
c. interposing a collimating aperture, characterized by an opening dimension, between the source of radiation and the object; and
d. varying the opening dimension of the collimating aperture periodically during the course of inspecting the object.

6. A method in accordance with claim 5, wherein the step of varying the opening dimension of the collimating aperture includes locating a fixed aperture of distinct opening at each of a plurality of periodically interposed channels.

7. A temporally modulated aperture opening for a beam of penetrating radiation, the aperture characterized by a cross-sectional dimension, the cross-sectional dimension capable of variation on a periodic basis in such a manner as to provide a specified radial profile of resolution versus penetrating power.
